(19) United States
(12) Patent Application Publication
(10) Pub. No.: US 2014/0245028 A1
(43) Pub. Date: Aug. 28, 2014

(54) SYSTEM AND METHOD FOR TEMPERATURE DRIVEN SELECTION OF VOLTAGE MODES IN A PORTABLE COMPUTING DEVICE

(71) Applicant: QUALCOMM INCORPORATED, San Diego, CA (US)

(72) Inventors: Wei Chen, San Diego, CA (US); Sorin Dobre, San Diego, CA (US); Ronald F. Alton, Oceanside, CA (US); Jon J. Anderson, Boulder, CO (US)

(73) Assignee: QUALCOMM Incorporated, San Diego, CA (US)

(21) Appl. No.: 13/773,842

(22) Filed: Feb. 22, 2013

(51) Int. Cl. G06F 1/26

(52) U.S. Cl. CPC G06F 1/26
USPC 713/300

(57) ABSTRACT

Various methods and systems for minimum supply voltage level selection in a portable computing device (“PCD”) are disclosed. It is an advantage of the various embodiments that PCD designers may close timing at a certain minimum supply voltage and operating temperature threshold that is higher than the lowest end of the main operating temperature range within which the PCD must function. By closing timing at the higher operating temperature threshold, relatively smaller components requiring relatively lower power consumption may be used in the PCD, thereby providing improved overall power consumption when the PCD is operating at operating temperatures above the threshold. To maintain functionality when operating temperatures fall below the threshold, the minimum supply voltage to the components is increased. The systems and methods sacrifice power consumption concerns below the operating temperature threshold in exchange for reduced form factors and improved power efficiencies in higher, more typical operating temperature conditions.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

The trend in PCD design is to increase functionality while decreasing the form factor. As a result, today's PCDs are typically limited in size from the outset of the design process and, therefore, room for components within a PCD often comes at a premium. Not surprisingly, therefore, a consideration in component selection for PCD designers and engineers is often the size of the component.

An advantage of smaller components beyond the inherent space savings they bring is reduced power requirements. Advantageously, at normal operating temperatures smaller components often consume less power than their larger brethren without a sacrifice in processing capacity. There is a tradeoff, however, because smaller components are susceptible to a “temperature reversal effect” that slows their processing speed when they are exposed to operating temperatures in the lower ranges of design specifications.

For example, it is a common requirement that PCDs be operable in a temperature range from −30° C. to 85° C. When operating below the 0° C. temperature point, for instance, the otherwise desirable low threshold power supply requirement of small components may be inadequate to maintain timing closure. Consequently, even though the smallest components may be perfectly adequate at medium range operating temperatures, designers are forced to select components that are large enough to combat the temperature reversal effect in colder operating environments.

Therefore, what is needed in the art is a system and method that allows for the use of components with low power thresholds in cold operating environments and improves yield and chipset robustness in PCDs. More specifically, what is needed in the art is a system and method that avoids timing closure failures in a PCD due to low operating temperatures by modifying supply voltage levels of processing components.

### SUMMARY OF THE DISCLOSURE

Various embodiments of methods and systems for minimum supply voltage level selection, i.e. voltage mode selection techniques, in a portable computing device (“PCD”) are disclosed. It is an advantage of the various embodiments that PCD designers may close timing at a certain minimum supply voltage and operating temperature threshold that is higher than the lowest end of the main operating temperature range within which the PCD must function. Advantageously, by closing timing at the higher operating temperature threshold, relatively smaller components requiring relatively lower power consumption may be used in the PCD, thereby providing improved overall power consumption when the PCD is operating at operating temperatures above the threshold. Notably, to maintain functionality when operating temperatures fall below the threshold, the minimum supply voltage to the components is increased so that functionality is maintained across the entire main operating temperature range. As one of ordinary skill in the art would recognize, the systems and methods sacrifice power consumption concerns below the operating temperature threshold in exchange for reduced form factors and improved power efficiencies in higher, more typical operating temperature conditions.

An exemplary method for voltage mode selection in a portable computing device (“PCD”) includes defining a first operating temperature threshold in the PCD. As mention above, the first operating temperature threshold may represent a temperature below which one or more components in the PCD cannot maintain timing closure at a first minimum supply voltage level. One or more temperature sensors, such as die level sensors on the chip, are monitored. If a temperature reading generated by the sensors indicates that the first operating temperature threshold has been crossed, then the minimum supply voltage may be adjusted. Notably, if the threshold is crossed such that the measured operating temperature is beneath the threshold, the minimum supply voltage may be adjusted upward to prevent components from slowing to such an extent that the circuit cannot meet timing closure requirements. Similarly, if the threshold is crossed such that the measured operating temperature is above the threshold, the minimum supply voltage may be adjusted downward so that excess power is not consumed by the components.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a functional block diagram illustrating an embodiment of an on-chip system for implementing voltage mode selection methodologies in a portable computing device (“PCD”);

FIG. 2 is a functional block diagram illustrating an exemplary, non-limiting aspect of the PCD of FIG. 1 in the form of a wireless telephone for implementing methods and systems for modifying threshold voltage levels supplied to processing components based on temperature readings;

FIG. 3A is a functional block diagram illustrating an exemplary spatial arrangement of hardware for the chip illustrated in FIG. 2;

FIG. 3B is a schematic diagram illustrating an exemplary software architecture of the PCD of FIG. 2 for voltage mode selection and minimum voltage level modification;

FIG. 4 is a logical flowchart illustrating a method for voltage mode selection in the PCD of FIG. 1;

FIG. 5 is a logical flowchart illustrating sub-method or subroutines for applying static voltage scaling (“SVS”) based on voltage modes.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” “processing component” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or a chip may be comprised of one or more distinct processing components generally referred to herein as “core(s).” Additionally, to the extent that a CPU, DSP, GPU, chip or core is a functional component within a PCD that consumes various levels of power to operate at various levels of functional efficiency, one of ordinary skill in the art will recognize that the use of these terms does not limit the application of the disclosed embodiments, or their equivalents, to the context of processing components within a PCD. That is, although many of the embodiments are described in the context of a processing component, it is envisioned that modal voltage selection methodologies may be applied to any functional component within a PCD including, but not limited to, a modem, a camera, a wireless network interface controller (“WNIC”), a display, a video encoder, a peripheral device, a battery, etc.

In this description, it will be understood that the terms “thermal” and “thermal energy” may be used in association with a device or component capable of generating or dissipating energy that can be measured in units of “temperature.” Similarly, terms such as “operating temperature” and “ambient temperature” are generally used interchangeably to reference the thermal conditions, as measured in units of “temperature,” to which a device or component is exposed. As such, one of ordinary skill in the art will recognize that the “operating temperature” to which a given device or component is exposed may be affected by the thermal energy dissipated from the device itself or other nearby thermal energy generating components. Moreover, it will further be understood that the term “temperature,” with reference to some standard value, envisions any measurement that may be indicative of the relative warmth, or absence of heat, of a “thermal energy” generating device or component. For example, the “temperature” of two components is the same when the two components are in “thermal” equilibrium.

In this description, the terms “workload,” “process load” and “process workload” are used interchangeably and generally directed toward the processing burden, or percentage of processing burden, associated with a given processing component in a given embodiment. Further to that which is defined above, a “processing component” or “thermal energy generating component” or “thermal aggressor” may be, but is not limited to, a central processing unit, a graphical processing unit, a core, a main core, a sub-core, a processing area, a hardware engine, etc. or any component residing within, or external to, an integrated circuit within a portable computing device.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

In this description, the terms “timing closure,” “close timing,” “closing timing” and the like will be understood by one of ordinary skill in the art as a reference to the circuit design consideration related to component selection in view of threshold voltage supply levels. Moreover, one of ordinary skill in the art will acknowledge that at a given threshold voltage supply level there is a low operating temperature limit below which the functionality of a given component becomes too slow to maintain circuit timing requirements. As such, “closing timing” at a certain low operating temperature dictates that components within a given circuit will be functional at the “timing closure” temperature given a minimum supply voltage.

Circuit designers and engineers select components that, among other things, are capable of operating at a given minimum or threshold voltage level while maintaining timing requirements across a specified range of operating temperatures. For example, PCD designers often must design circuits capable of functioning in ambient environments ranging from −30° C. to 85° C. and, as such, close timing in their designs at −30° C. when selecting circuit components. Notably, although various embodiments are described herein relative to a scenario wherein a PCD has an operating temperature range of −30° C. to 85° C., it will be understood that these embodiments are being offered for illustrative purposes and reference to such an operating range does not limit applications of the embodiments to PCDs designed for an operating range of −30° C. to 85° C. Other operating ranges are envisioned.

For a circuit to function properly across an entire operating temperature range, one of ordinary skill in the art will recognize that timing margins must be maintained on all clock edges across the circuit. That is, as signals propagate through a chain of transistors, for instance, all the transistors have to perform their function within an amount of time defined by timing edges (i.e., within a “window of time”); otherwise, the circuit will not function properly.

Notably, as the operating temperature for a transistor varies, the speed at which the transistor switches also varies. As mentioned above, the amount of variance in switching speeds across the target range of operating temperatures must be considered by designers when selecting components. At what temperature the designer chooses to close timing dictates component selection, such as transistor size. For instance, if timing is closed at −30° C., then a selected transistor must be capable of handling the required switching speed at −30° C. and at whatever minimum voltage the designer intends to provide the circuit. Notably, if the designer increases the threshold voltage, then a smaller transistor may be selected. If, on the other hand, the designer elects to run at a relatively lower minimum voltage in an effort to save on power consumption, relatively larger transistors will be required.

Essentially, timing closure in a circuit design dictates either 1) selection of relatively larger transistors which can function at relatively lower threshold power levels when exposed to the low end of an operating temperature range or 2) selection of smaller transistors that require relatively higher threshold power levels in order to function at the low end of the operating temperature range. Notably, as one of ordinary skill in the art would recognize, the tradeoff is form factor size versus power consumption.

To guarantee that a circuit will close timing at the lowest temperature of an operating temperature range, choosing larger components may guarantee functionality at a low operating temperature at the expense of an increased form factor and an unnecessarily high rate of power consumption when the PCD is operating at higher temperatures. Conversely, choosing smaller components may save space and power consumption at mid-range operating temperatures, but risk a loss of function at lower operating temperatures. Simply stated, timing closure considerations at lower operating temperatures usually dictates transistor selection during the design phase of a PCD that would not be considered an optimal selection for when the PCD is operating at mid and upper range operating temperatures.

Advantageously, embodiments of the systems and methods enable timing to be closed at an operating temperature breakpoint that is within a broader operating temperature range for which the PCD is designed. As such, relatively smaller components capable of maintaining timing at or above the temperature breakpoint given a certain minimum supply voltage, but not at the lower temperature of the broader operating temperature range (assuming the same minimum supply voltage), may be used. Accordingly, it is envisioned that certain embodiments will be directed to PCDs that include 28 nm, 20 nm, and/or 16 nm or smaller nodes.

In operation, the system and methods monitor the actual operating temperature and, should the operating temperature approach or fall beneath the temperature breakpoint, the minimum supply voltage may be increased to the various components. In this way, given that the PCD may operate a majority of the time at an operating temperature above the temperature breakpoint, power savings and form factor advantages associated with the smaller components may be realized. Notably, as one of ordinary skill in the art would acknowledge, the PCD may rarely be asked to function at an operating temperature below the breakpoint temperature and, as such, the increased power consumption that would result from increasing the minimum supply voltage when the operating temperature falls below the breakpoint represents a favorable design tradeoff

A system and method for applying voltage modes to PCD components such that timing may be closed at an operating temperature that is within a broader operating temperature range can be accomplished by leveraging one or more sensor measurements that correlate with one or more of the temperatures of silicon junctions in core(s), package on package (“PoP”) memory components, outer shell, i.e. “skin,” of the PCD, etc. By closely monitoring the temperatures associated with such components, a voltage mode selection module in a PCD may cause an increase or decrease in the minimum supply voltage to component(s) in order to maintain functionality while optimizing average power consumption.

Notably, although exemplary embodiments of voltage mode selection methods are described herein in the context of a single operating temperature breakpoint, it is envisioned that some embodiments may take advantage of multiple temperature thresholds or breakpoints and, as such, the disclosure will not be limited to embodiments that monitor for a single operating temperature threshold as a trigger to change voltage modes. For instance, although one of ordinary skill in the art will recognize that a given circuit's timing must be closed at a selected temperature point, it is envisioned that some embodiments may define multiple temperature breakpoints below the temperature at which timing was closed. In such embodiments, a series of voltage modes may be defined in association with temperature ranges between the breakpoints and the minimum supply voltage modified each time that an operating temperature reading indicates a crossover into a given range.

As a non-limiting example of how a temperature driven selection of voltage modes may be applied in an exemplary PCD, sampling of die level temperature sensors may occur at the time that a PCD is initially powered on. In doing so, embodiments may determine the initial operating temperature of the PCD. If the operating temperature determined from the initial sampling indicates that the PCD is below the timing closure breakpoint (such as, for example, below a timing closure breakpoint of 0° C. for a PCD designed to be functional across a broader operating temperature range of −30° C. to 85° C.), a voltage mode selection (“VMS”) module may cause a static voltage scaling (“SVS”) level to be increased to a minimum voltage supply needed to ensure that components maintain timing closure. Notably, as one of ordinary skill in the art will recognize, the various temperature sensors monitored in a voltage mode selection system may generate temperature readings that closely indicate actual operating temperatures of the components with which the sensors are associated or, in the alternative, may generate temperature readings from which actual temperatures of certain components may be inferred.

Returning to the non-limiting example, if the operating temperature determined from the initial sampling indicates that the PCD is at or above the timing closure breakpoint (such as, for example, at or above a timing closure breakpoint of 0° C. for a PCD designed to be functional across a broader operating temperature range of −30° C. to 85° C.), a VMS module may dictate that a default SVS level be held at the relatively lower minimum voltage supply required to maintain timing closure at operating temperatures above the temperature breakpoint.

In another non-limiting example, embodiments of a VMS system and method may be implemented in a PCD that is in a collapsed power state (e.g., in a “sleep” mode). As one of ordinary skill in the art would understand, in such a scenario the PCD may “wake up” every so often to monitor paging channels on the modem, check temperature sensors, etc. During the wakeup period, should it be recognized that a monitored temperature associated with the operating temperature of the PCD has fallen below a temperature breakpoint, a VMS module may cause the PCD to be awakened and minimum supply voltages increased to ensure proper timing closure is maintained. Advantageously, by waking the PCD, recognizing that the operating temperature has fallen below a temperature breakpoint and then increasing the supply voltage, the PCD may be allowed to return to its sleep state without the risk that it will become dysfunctional due to low thermal energy levels.

Notably, although the various embodiments described in this specification include temperature readings associated with die level junction sensors, PoP sensors and/or skin temperature sensors, it is envisioned that some embodiments of VMS system may not monitor junction, PoP and skin temperatures. That is, it is envisioned that some embodiments may monitor temperatures associated with other combinations of components and, as such, embodiments of VMS system and method will not be limited to specifically monitoring temperatures associated with the exemplary combinations of components illustrated in this description.

Returning to the non-limiting examples, by monitoring the timing closure temperature breakpoint, the VMS module may cause the minimum supply voltage to be adjusted up or down such that power consumption and PCD functionality is optimized in view of operating temperature.

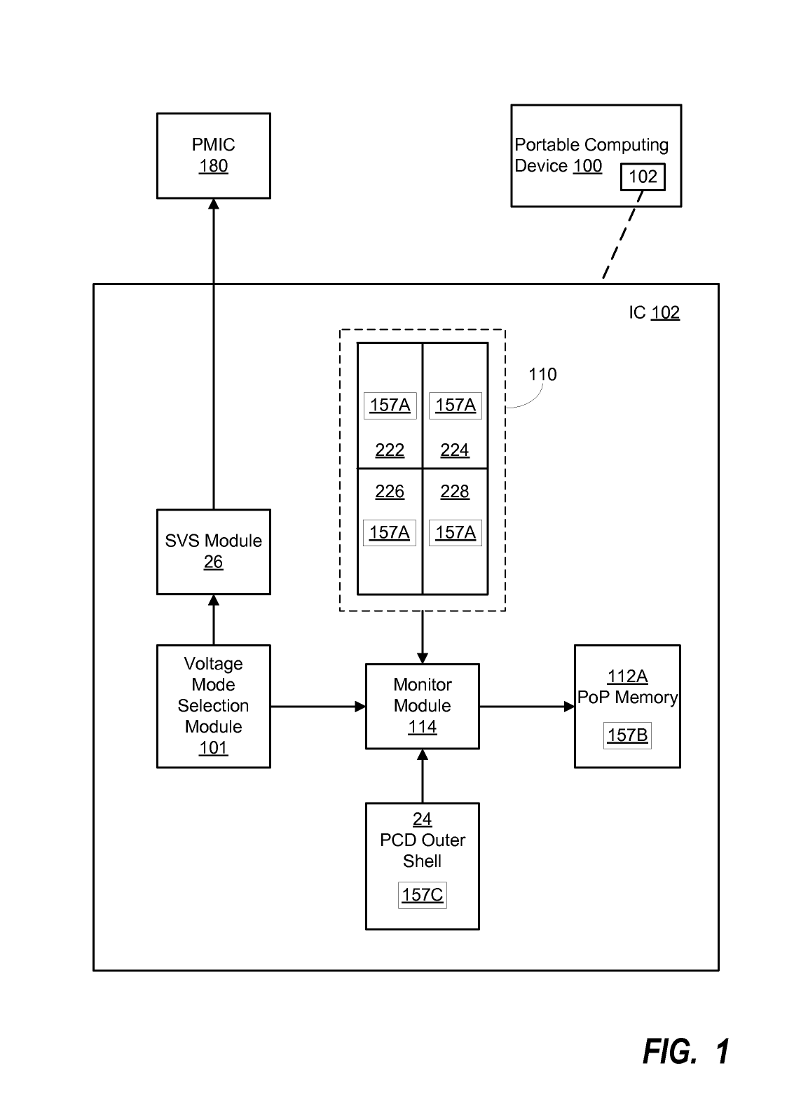

FIG. 1 is a functional block diagram illustrating an exemplary embodiment of an on-chip system 102 for temperature based voltage mode selection in a portable computing device 100. To monitor operating temperatures against a temperature threshold associated with timing closure, the on-chip system 102 may leverage various sensors 157 for measuring temperatures associated with various components such as junctions of cores 222, 224, 226, 228, PoP memory 112A and PCD outer shell 24. Advantageously, by monitoring the temperatures associated with the various components and recognizing when an operating temperature has crossed over a temperature breakpoint associated with the circuit's timing closure, the power consumption of the PCD 100 may be optimized while the PCD 100 is exposed to an operating temperature above the breakpoint. Moreover, smaller form factors may be realized as relatively smaller components capable of maintaining timing closure at operating temperatures above the breakpoint are used in lieu of the relatively larger components that would normally be required in order to guarantee functionality at the low end of a broader operating temperature range.

In general, the system employs two main modules which, in some embodiments, may be contained in a single module: (1) a voltage mode selection (“VMS”) module 101 for analyzing temperature readings monitored by a monitor module 114 (notably, monitor module 114 and VMS module 101 may be one and the same in some embodiments) and triggering voltage mode adjustments; and (2) a static voltage scaling (“SVS”) module 26 for causing minimum supply voltages delivered on power rails to individual components to be adjusted according to instructions received from VMS module 101. Advantageously, embodiments of the system and method that include the two main modules leverage temperature data to optimize the average power consumption within the PCD 100 while maintaining functionality across a broad operating temperature range.

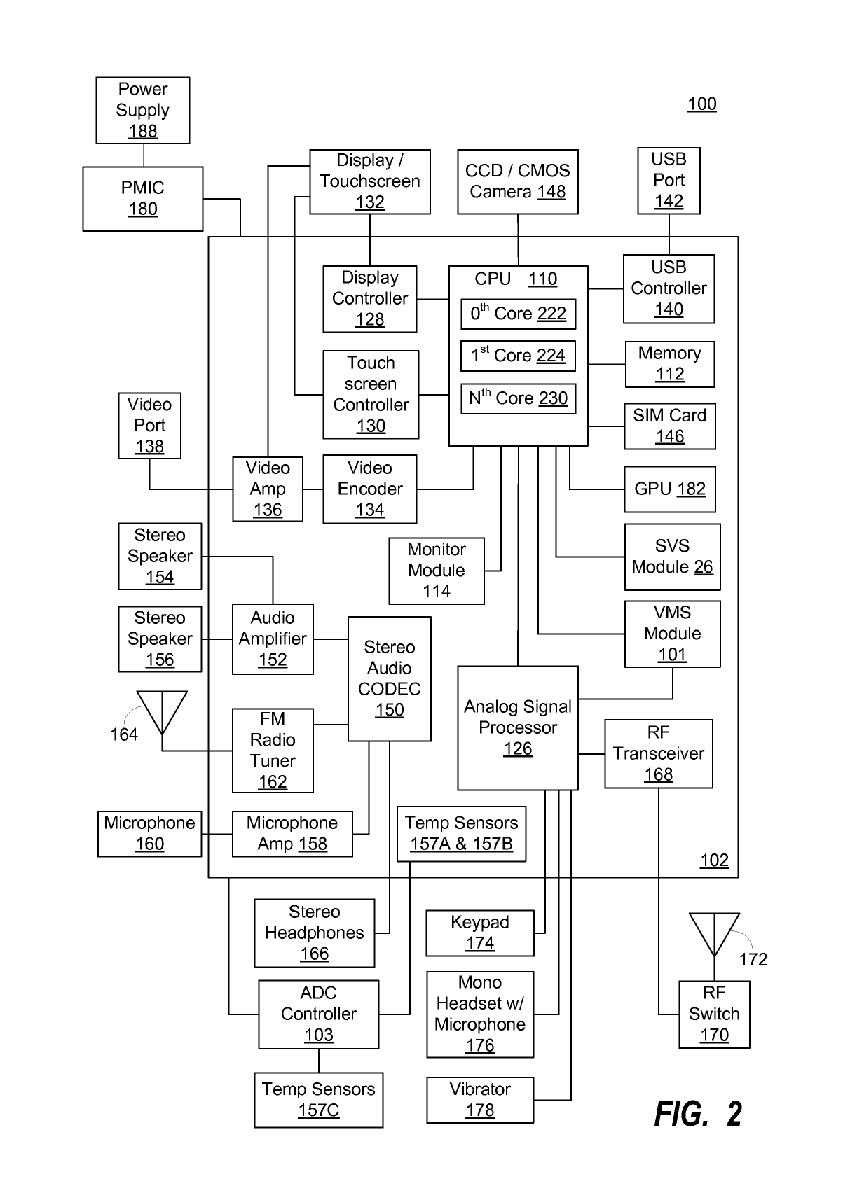

FIG. 2 is a functional block diagram illustrating an exemplary, non-limiting aspect of the PCD 100 of FIG. 1 in the form of a wireless telephone for implementing methods and systems for modifying threshold voltage levels supplied to processing components based on temperature readings. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, the static voltage scaling (“SVS”) module 26 may be responsible for implementing increases or decreases to minimum supply voltages delivered to power consuming components, such as cores 222, 224, 230 to help a PCD 100 optimize its average power consumption when operating at typical operating temperatures yet maintain functionality when operating temperatures fall below certain temperature thresholds.

The monitor module 114 communicates with multiple operational sensors (e.g., thermal sensors 157A, 157B) distributed throughout the on-chip system 102 and with the CPU 110 of the PCD 100 as well as with the VMS module 101. In some embodiments, monitor module 114 may also monitor skin temperature sensors 157C for temperature readings associated with a touch temperature or ambient environmental temperature of PCD 100. In other embodiments, monitor module 114 may infer ambient environmental temperatures based on a likely delta with readings taken by on chip temperature sensors 157A, 157B. The VMS module 101 may work with the monitor module 114 to identify temperature breakpoints that have been crossed and instruct the SVS module to reduce or increase minimum supply voltages such that timing closure is maintained.

As illustrated in FIG. 2, a display controller 128 and a touch screen controller 130 are coupled to the digital signal processor 110. A touch screen display 132 external to the on-chip system 102 is coupled to the display controller 128 and the touch screen controller 130. PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core central processing unit (“CPU”) 110. A video amplifier 136 is coupled to the video encoder 134 and the touch screen display 132. A video port 138 is coupled to the video amplifier 136. As depicted in FIG. 2, a universal serial bus (“USB”) controller 140 is coupled to the CPU 110. Also, a USB port 142 is coupled to the USB controller 140. A memory 112 and a subscriber identity module (SIM) card 146 may also be coupled to the CPU 110. Further, as shown in FIG. 2, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 2, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 2 shows that a microphone amplifier 158 may also be coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 2 further indicates that a radio frequency (“RF”) transceiver 168 may be coupled to the analog signal processor 126. An RF switch 170 may be coupled to the RF transceiver 168 and an RF antenna 172. As shown in FIG. 2, a keypad 174 may be coupled to the analog signal processor 126. Also, a mono headset with a microphone 176 may be coupled to the analog signal processor 126. Further, a vibrator device 178 may be coupled to the analog signal processor 126. FIG. 2 also shows that a power supply 188, for example a battery, is coupled to the on-chip system 102 through PMIC 180. In a particular aspect, the power supply includes a rechargeable DC battery or a DC power supply that is derived from an alternating current (“AC”) to DC transformer that is connected to an AC power source. The SVS module 26 may work with the PMIC 180 to reduce or increase minimum supply voltages based on changes in voltage modes triggered by crossover of a temperature threshold.

The CPU 110 may also be coupled to one or more internal, on-chip thermal sensors 157A as well as one or more external, off-chip thermal sensors 157C. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157C may comprise one or more thermistors. The thermal sensors 157C may produce a voltage drop that is converted to digital signals with an analog-to-digital converter (“ADC”) controller 103. However, other types of thermal sensors 157A, 157B, 157C may be employed without departing from the scope of the invention.

The SVS module(s) 26 and VMS module(s) 101 may comprise software which is executed by the CPU 110. However, the SVS module(s) 26 and VMS module(s) 101 may also be formed from hardware and/or firmware without departing from the scope of the invention. The VMS module(s) 101 in conjunction with the SVS module(s) 26 may be responsible for dictating changes in minimum voltage supplies that may help a PCD 100 maintain functionality on the low end of an operating temperature range while optimizing power consumption at higher, more common operating temperatures.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, the power supply 188, the PMIC 180 and the thermal sensors 157C are external to the on-chip system 102. However, it should be understood that the monitor module 114 may also receive one or more indications or signals from one or more of these external devices by way of the analog signal processor 126 and the CPU 110 to aid in the real time management of the resources operable on the PCD 100.

In a particular aspect, one or more of the method steps described herein may be implemented by executable instructions and parameters stored in the memory 112 that form the one or more VMS module(s) 101 and SVS module(s) 26. These instructions that form the module(s) 101, 26 may be executed by the CPU 110, the analog signal processor 126, or another processor, in addition to the ADC controller 103 to perform the methods described herein. Further, the processors 110, 126, the memory 112, the instructions stored therein, or a combination thereof may serve as a means for performing one or more of the method steps described herein.

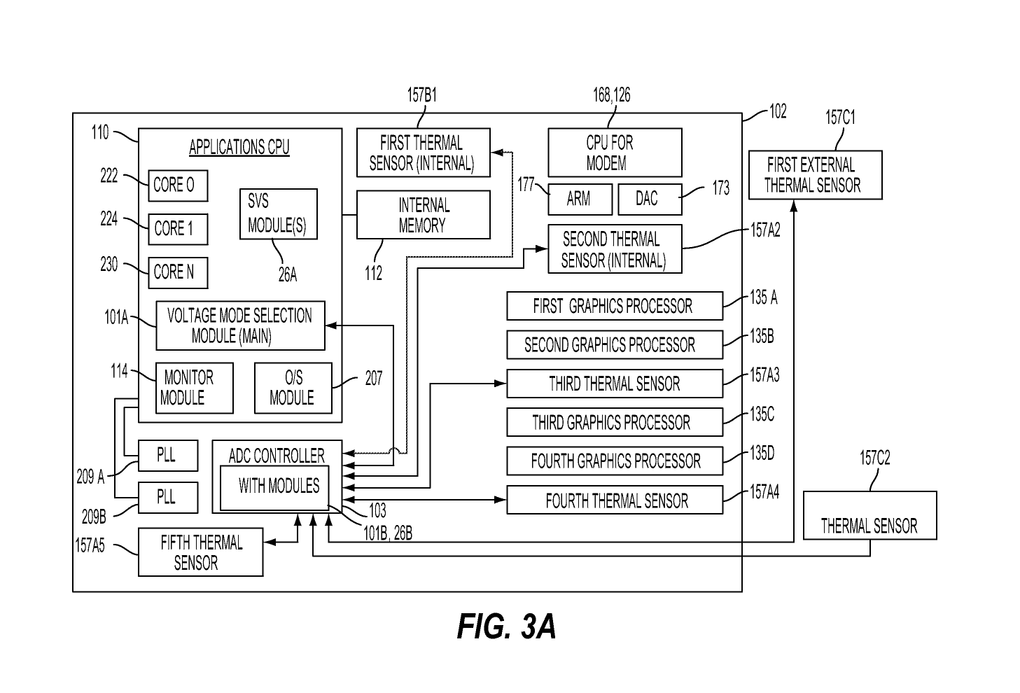

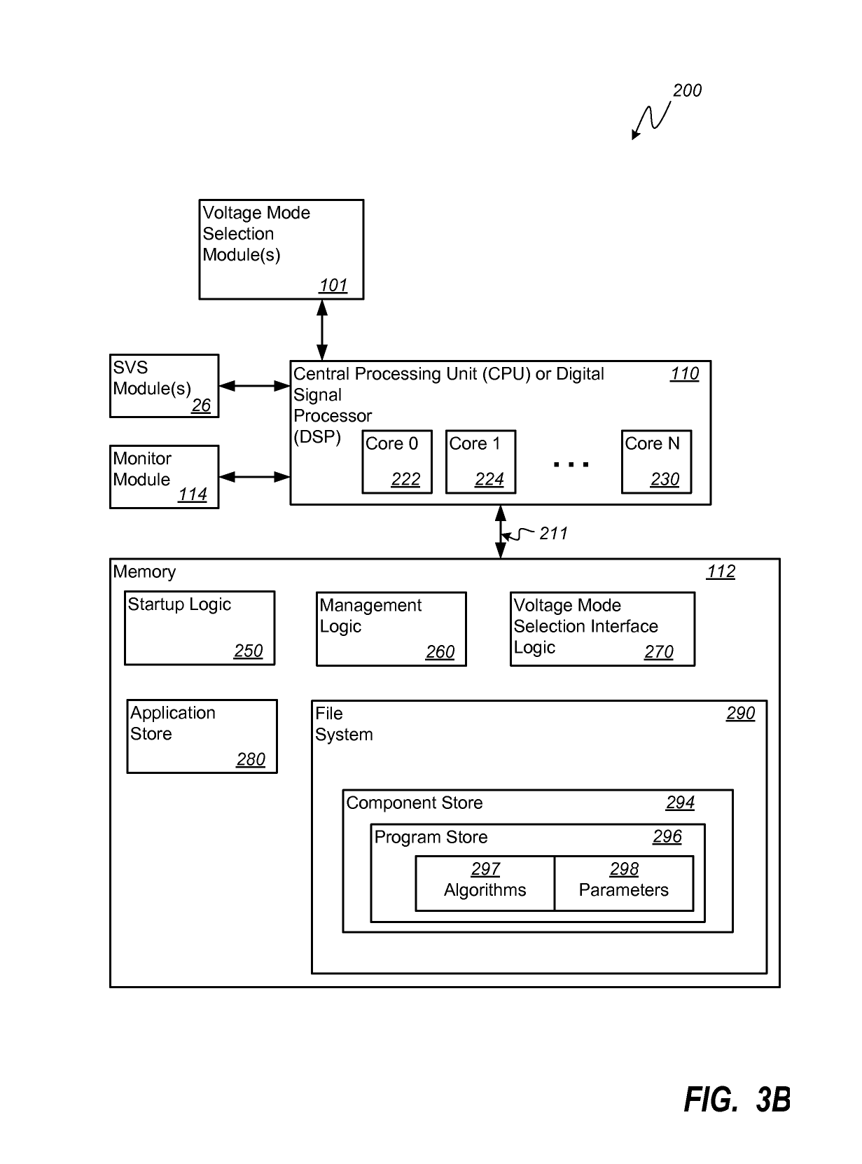

FIG. 3A is a functional block diagram illustrating an exemplary spatial arrangement of hardware for the chip 102 illustrated in FIG. 2. According to this exemplary embodiment, the applications CPU 110 is positioned on the far left side region of the chip 102 while the modem CPU 168, 126 is positioned on a far right side region of the chip 102. The applications CPU 110 may comprise a multi-core processor that includes a zeroth core 222, a first core 224, and an Nth core 230. The applications CPU 110 may be executing a VMS module 101A and/or SVS module 26A (when embodied in software) or it may include a VMS module 101A and/or SVS module 26A (when embodied in hardware). The application CPU 110 is further illustrated to include operating system (“O/S”) module 207 and a monitor module 114. Further details about the monitor module 114 will be described below in connection with FIG. 3B.

The applications CPU 110 may be coupled to one or more phase locked loops (“PLLs”) 209A, 209B, which are positioned adjacent to the applications CPU 110 and in the left side region of the chip 102. Adjacent to the PLLs 209A, 209B and below the applications CPU 110 may comprise an analog-to-digital (“ADC”) controller 103 that may include its own voltage mode selection module 101B and/or SVS module 26B that works in conjunction with the main modules 101A, 26A of the applications CPU 110.

The VMS module 101B of the ADC controller 103 may be responsible for monitoring and tracking multiple thermal sensors 157 that may be provided “on-chip” 102 and “off-chip” 102. The on-chip or internal thermal sensors 157A, 157B may be positioned at various locations and associated with operating temperatures of components proximal to the locations (such as with sensor 157A3 next to second and third thermal graphics processors 135B and 135C) or temperature sensitive components (such as with sensor 157B1 next to memory 112).

As a non-limiting example, a first internal thermal sensor 157B1 may be positioned in a top center region of the chip 102 between the applications CPU 110 and the modem CPU 168,126 and adjacent to internal memory 112. A second internal thermal sensor 157A2 may be positioned below the modem CPU 168, 126 on a right side region of the chip 102. This second internal thermal sensor 157A2 may also be positioned between an advanced reduced instruction set computer (“RISC”) instruction set machine (“ARM”) 177 and a first graphics processor 135A. A digital-to-analog controller (“DAC”) 173 may be positioned between the second internal thermal sensor 157A2 and the modem CPU 168, 126.

A third internal thermal sensor 157A3 may be positioned between a second graphics processor 135B and a third graphics processor 135C in a far right region of the chip 102. A fourth internal thermal sensor 157A4 may be positioned in a far right region of the chip 102 and beneath a fourth graphics processor 135D. And a fifth internal thermal sensor 157A5 may be positioned in a far left region of the chip 102 and adjacent to the PLLs 209 and ADC controller 103.

One or more external thermal sensors 157C may also be coupled to the ADC controller 103. The first external thermal sensor 157C1 may be positioned off-chip and adjacent to a top right quadrant of the chip 102 that may include the modem CPU 168, 126, the ARM 177, and DAC 173. A second external thermal sensor 157C2 may be positioned off-chip and adjacent to a lower right quadrant of the chip 102 that may include the third and fourth graphics processors 135C, 135D. Notably, one or more of external thermal sensors 157C may be leveraged to indicate the touch temperature or ambient environmental temperature of the PCD 100.

One of ordinary skill in the art will recognize that various other spatial arrangements of the hardware illustrated in FIG. 3A may be provided without departing from the scope of the invention. FIG. 3A illustrates yet one exemplary spatial arrangement and how the main VMS and SVS modules 101A, 26A and ADC controller 103 with its VMS and SVS modules 101B, 26B may recognize thermal operating conditions that are a function of the exemplary spatial arrangement illustrated in FIG. 3A, compare temperature thresholds or breakpoints with operating temperatures and select voltage modes.

FIG. 3B is a schematic diagram illustrating an exemplary software architecture of the PCD 100 of FIG. 2 and FIG. 3A for supporting voltage mode selection and minimum voltage level modification. Any number of algorithms may form or be part of at least one voltage modification policy that may be applied by the VMS module 101 when certain thermal conditions are met, however, in a preferred embodiment the VMS module 101 works with the SVS module 26 to increase minimum voltage levels to individual components in chip 102 when it is recognized that the operating temperature has fallen below a temperature breakpoint associated with timing closure. Notably, by increasing the minimum supply voltage when the PCD 100 is exposed to relatively low operating temperatures, the functionality of the PCD 100 may be maintained in lower temperatures while power savings are realized from a reduced minimum supply voltage when the PCD 100 is operating at temperatures above the breakpoint.

As illustrated in FIG. 3B, the CPU or digital signal processor 110 is coupled to the memory 112 via a bus 211. The CPU 110, as noted above, is a multiple-core processor having N core processors. That is, the CPU 110 includes a first core 222, a second core 224, and an N^{th} core 230. As is known to one of ordinary skill in the art, each of the first core 222, the second core 224 and the N^{th} core 230 are available for supporting a dedicated application or program. Alternatively, one or more applications or programs can be distributed for processing across two or more of the available cores.

The CPU 110 may receive commands from the VMS module(s) 101 and/or SVS module(s) 26 that may comprise software and/or hardware. If embodied as software, the module(s) 101, 26 comprise instructions that are executed by the CPU 110 that issues commands to other application programs being executed by the CPU 110 and other processors.

The first core 222, the second core 224 through to the Nth core 230 of the CPU 110 may be integrated on a single integrated circuit die, or they may be integrated or coupled on separate dies in a multiple-circuit package. Designers may couple the first core 222, the second core 224 through to the N^{th} core 230 via one or more shared caches and they may implement message or instruction passing via network topologies such as bus, ring, mesh and crossbar topologies.

Bus 211 may include multiple communication paths via one or more wired or wireless connections, as is known in the art. The bus 211 may have additional elements, which are omitted for simplicity, such as controllers, buffers (caches), drivers, repeaters, and receivers, to enable communications. Further, the bus 211 may include address, control, and/or data connections to enable appropriate communications among the aforementioned components.

When the logic used by the PCD 100 is implemented in software, as is shown in FIG. 3B, it should be noted that one or more of startup logic 250, management logic 260, voltage mode selection interface logic 270, applications in application store 280 and portions of the file system 290 may be stored on any computer-readable medium or device for use by, or in connection with, any computer-related system or method.

In the context of this document, a computer-readable medium or device is an electronic, magnetic, optical, or other physical device or means that can contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where one or more of the startup logic 250, management logic 260 and perhaps the voltage mode selection interface logic 270 are implemented in hardware, the various logic may be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The memory 112 is a non-volatile data storage device such as a flash memory or a solid-state memory device. Although depicted as a single device, the memory 112 may be a distributed memory device with separate data stores coupled to the digital signal processor 110 (or additional processor cores).

The startup logic 250 includes one or more executable instructions for selectively identifying, loading, and executing a select program for managing or controlling the minimum supply voltages of various components within PCD 100. The startup logic 250 may identify, load and execute a select program based on the comparison, by the VMS module 101, of various temperature measurements with threshold temperature settings associated with a PCD component or aspect. An exemplary select program can be found in the program store 296 of the embedded file system 290 and is defined by a specific combination of algorithms 297 and a set of parameters 298. The exemplary select program, when executed by one or more of the core processors in the CPU 110 may operate in accordance with one or more signals provided by the monitor module 114 in combination with control signals provided by the one or more VMS module(s) 101 and SVS module(s) 26 to scale the minimum supply voltage of various components “up” or “down.” In this regard, the monitor module 114 may provide one or more indicators of events, processes, applications, resource status conditions, elapsed time, as well as temperature as received from the VMS module 101.

The management logic 260 includes one or more executable instructions for terminating a program on one or more of the respective processor cores, as well as selectively identifying, loading, and executing a more suitable replacement program for managing or controlling the minimum supply voltages. The management logic 260 is arranged to perform these functions at run time or while the PCD 100 is powered and in use by an operator of the device. A replacement program can be found in the program store 296 of the embedded file system 290.

The replacement program, when executed by one or more of the core processors in the digital signal processor may operate in accordance with one or more signals provided by the monitor module 114 or one or more signals provided on the respective control inputs of the various processor cores to modify minimum supply voltages to components. In this regard, the monitor module 114 may provide one or more indicators of events, processes, applications, resource status conditions, elapsed time, temperature, etc in response to control signals originating from the VMS 101.

The interface logic 270 includes one or more executable instructions for presenting, managing and interacting with external inputs to observe, configure, or otherwise update information stored in the embedded file system 290. In one embodiment, the interface logic 270 may operate in conjunction with manufacturer inputs received via the USB port 142. These inputs may include one or more programs to be deleted from or added to the program store 296. Alternatively, the inputs may include edits or changes to one or more of the programs in the program store 296. Moreover, the inputs may identify one or more changes to, or entire replacements of one or both of the startup logic 250 and the management logic 260.

The interface logic 270 enables a manufacturer to controllably configure and adjust an end user's experience under defined operating conditions on the PCD 100. When the memory 112 is a flash memory, one or more of the startup logic 250, the management logic 260, the interface logic 270, the application programs in the application store 280 or information in the embedded file system 290 can be edited, replaced, or otherwise modified. In some embodiments, the interface logic 270 may permit an end user or operator of the PCD 100 to search, locate, modify or replace the startup logic 250, the management logic 260, applications in the application store 280 and information in the embedded file system 290. The operator may use the resulting interface to make changes that will be implemented upon the next startup of the PCD 100. Alternatively, the operator may use the resulting interface to make changes that are implemented during run time.

The embedded file system 290 includes a hierarchically arranged program store 296. In this regard, the file system 290 may include a reserved section of its total file system capacity for the storage of information for the configuration and management of the various parameters 298 and algorithms 297 used by the PCD 100. As shown in FIG. 3B, the store 296 includes a component store 294, which includes a program store 296, which includes one or more voltage mode selection programs.

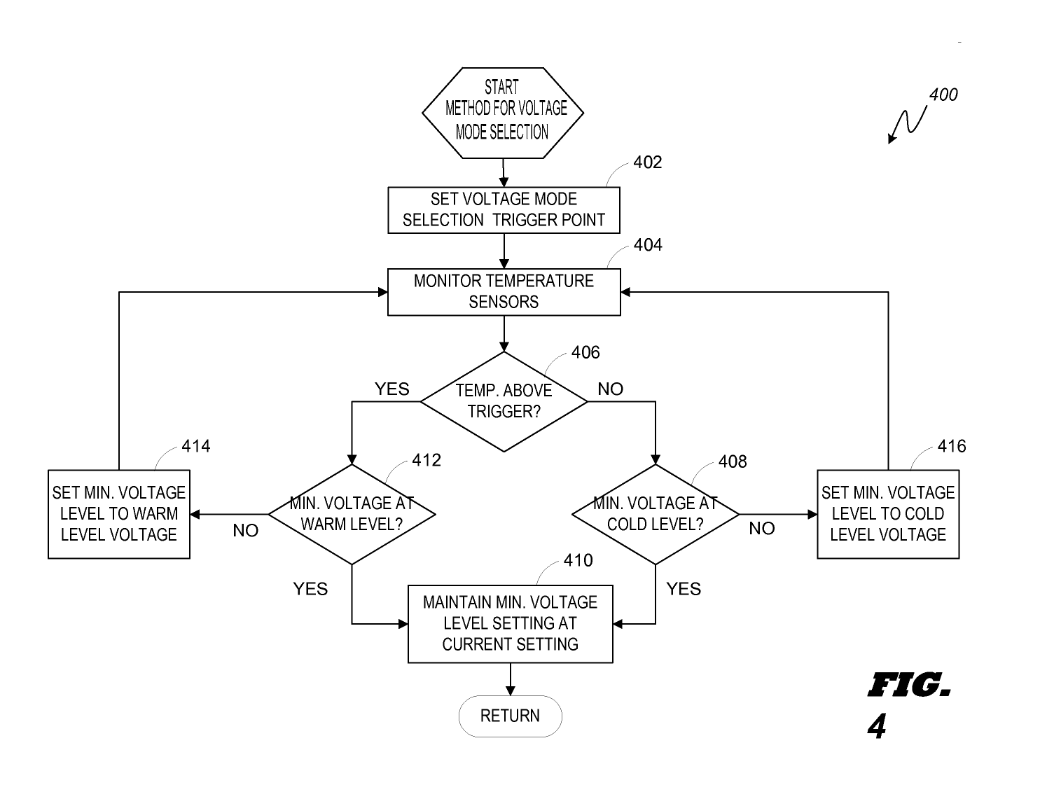

FIG. 4 is a logical flowchart illustrating a method 400 for voltage mode selection in the PCD 100. Method 400 of FIG. 4 starts with a first block 402 where the voltage mode trigger point(s) is set. A trigger point is an operating temperature and may be also be the temperature at which timing was closed during the design of the PCD 100. As such, and as described above, the PCD 100 may comprise components that, at a given minimum supply voltage, maintain suitable functionality at temperatures at or above the trigger point. Conversely, the same components may become too slow to maintain suitable timing closure at temperatures below the trigger point without an increase in the minimum supply voltage.

Returning to the method 400, at block 404 temperature sensors, such as die level sensors monitoring thermal energy levels at or near junctions, are monitored. Notably, the temperature readings generated by the temperature sensors may be indicative of operating temperature conditions. At decision block 406, the temperature readings are compared against the trigger point(s). If the temperature reading is above a trigger point, the “yes” branch is followed to decision block 412 and the SVS module 26 may determine whether the minimum voltage level is set to the minimum voltage associated with a warm level voltage mode. If the minimum voltage is already set to a voltage level consistent with a warm level voltage mode, then the “yes” branch is followed to block 410 and the minimum voltage is maintained. If not, the “no” branch is followed to block 414 and the SVS module 26 may work with the PMIC 180 to decrease the minimum voltage level such that power savings are optimized at the components. The method then returns to block 404 and monitoring of the temperature sensors continues.

Returning to decision block 406, if the temperature reading is below the trigger point, then the “no” branch is followed to decision block 408. Notably, if the trigger point is associated with an operating temperature the represents the lower limit at which timing will close given a certain minimum supply voltage level, a temperature reading below the trigger point indicates that functionality of the PCD 100 may be at risk. Consequently, if it is determined at decision block 408, that the minimum voltage level is not set to a voltage level consistent with a cold level voltage mode, the method moves to block 416 and the VMS module 101 and SVS module 26 work with the PMIC 180 to increase the minimum voltage supply. In doing so, the various components in the PCD 100 may be able to meet timing closure requirements and maintain functionality at the operating temperatures below the trigger point. The method subsequently returns to block 404 and monitoring of the temperature sensors continues.

Returning to decision block 408, if it is determined that the minimum supply voltage is already set to a level consistent with a cold level voltage mode, then the “yes” branch is followed to block 410 and the minimum supply voltage level is maintain. The process returns and monitoring continues.

Notably, as described above, it is envisioned that some embodiments may have multiple trigger points with the operating temperature ranges defined between them being associated with a certain voltage mode. The highest trigger point in an embodiment with a plurality of trigger points may also be associated with the operating temperature at which timing was closed during the design phase of the PCD 100. The process by which temperature readings are compared against the trigger points and voltage modes selected for modification of minimum supply voltages according to those comparisons may be represented by the method 400.

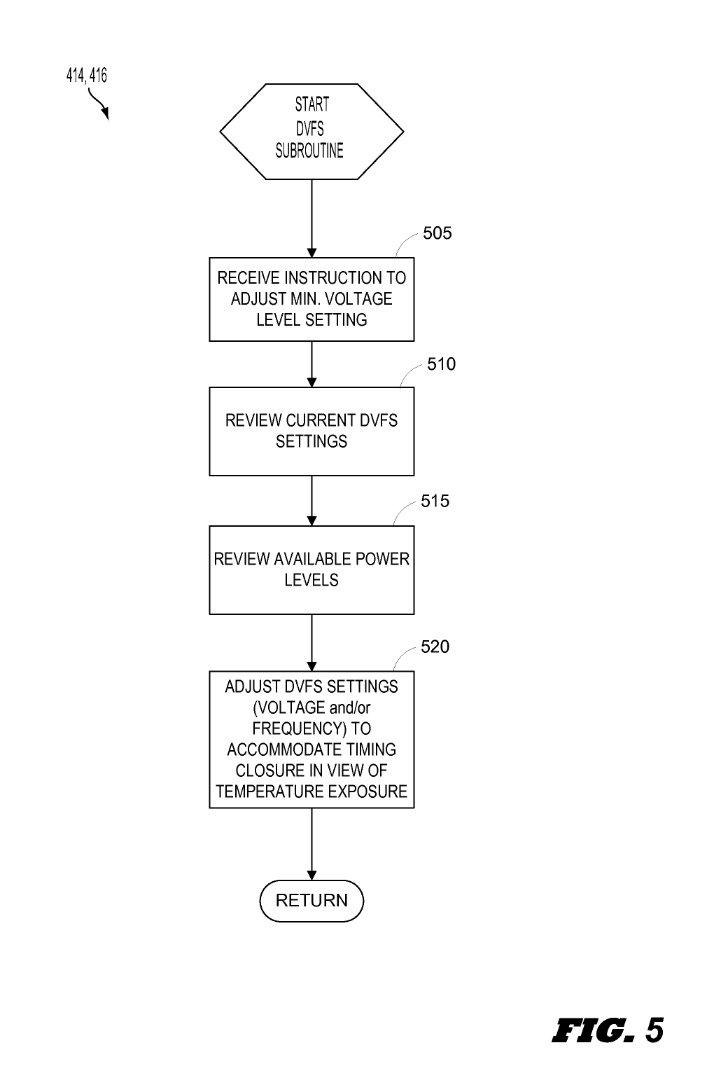

FIG. 5 is a logical flowchart illustrating a sub-method or subroutine 414, 416 for applying static voltage scaling (“SVS”) based on voltage modes. As described above, SVS techniques may be leveraged by a VMS module 101 and/or SVS module 26 in the application of voltage modes that modify minimum supply voltage settings. In certain embodiments, the SVS techniques may be applied to the power supplies to individual components while in other embodiments they may be applied to a plurality of components or even all components.

Block 505 is the first step in the submethod or subroutine 414, 416 for applying SVS techniques in a voltage mode framework. In the first block 505, the VMS module 101 and/or the monitor module 114 may determine that a temperature threshold or trigger, such as a junction operating temperature threshold, has been violated based on temperature readings provided by thermal sensors 157A. Accordingly, the VMS module 101 may then initiate instructions to the SVS module 26 to review the current SVS settings in block 510. Next, in block 515, the SVS module 26 may determine that the minimum supply power level of the processing component can be reduced or increased.

Next, in block 520, the SVS module 26 may adjust the current minimum supply voltage level, in order to maintain functionality or optimize power consumption, as the case may be. Adjusting the settings may comprise adjusting or “scaling” the minimum supply voltage allowed in a SVS algorithm. Notably, although the monitor module 114, VMS module 101 and SVS module 26 have been described in the present disclosure as separate modules with separate functionality, it will be understood that in some embodiments the various modules, or aspects of the various modules, may be combined into a common module for implementing adaptive thermal management policies.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for voltage mode selection in a portable computing device (“PCD”), the method comprising:
defining a first operating temperature threshold in the PCD, wherein the operating temperature threshold represents a temperature below which one or more components in the PCD cannot maintain timing closure at a first minimum supply voltage level;
monitoring one or more temperature sensors in the PCD;
receiving a signal from one of the one or more temperature sensors, wherein the signal indicates that the first operating temperature threshold has been achieved; and
in response to the first operating temperature threshold being achieved, adjusting the first minimum supply voltage level of one or more of the components to a second minimum supply level.

2. The method of claim 1, wherein the second minimum supply voltage level is higher than the first minimum supply voltage level.

3. The method of claim 1, wherein the second minimum supply voltage level is lower than the first minimum supply voltage level.

4. The method of claim 1, further comprising:
recognizing that the temperature threshold has been crossed a second time; and
adjusting the second minimum voltage supply level back to the first minimum voltage supply level.

5. The method of claim 1, wherein at least one of the one or more temperature sensors is a die level temperature sensor.

6. The method of claim 5, wherein the die level temperature sensor is associated with a junction.

7. The method of claim 1, wherein at least one of the one or more temperature sensors is associated with an outer shell aspect of the PCD.

8. The method of claim 1, further comprising:
defining a second operating temperature threshold in the PCD, wherein the operating temperature threshold represents a temperature below which one or more components in the PCD cannot maintain timing closure at the second minimum supply voltage level;
receiving a signal from one of the one or more temperature sensors, wherein the signal indicates that the second operating temperature threshold has been crossed; and
adjusting the second minimum supply voltage level of one or more of the components to a third minimum supply level.

9. The method of claim 8, wherein the third minimum supply voltage level is higher than the second minimum supply voltage level.

10. The method of claim 8, wherein the third minimum supply voltage level is lower than the second minimum supply voltage level.

11. A computer system for voltage mode selection in a portable computing device (“PCD”), the system comprising:
a voltage mode selection (“VMS”) module, configured to:
define a first operating temperature threshold in the PCD, wherein the operating temperature threshold represents a temperature below which one or more components in the PCD cannot maintain timing closure at a first minimum supply voltage level;
monitor one or more temperature sensors in the PCD;
receive a signal from one of the one or more temperature sensors, wherein the signal indicates that the first operating temperature threshold has been achieved; and
a static voltage scaling (“SVS”) module, configured to:
in response to the first operating temperature threshold being achieved, adjust the first minimum supply voltage level of one or more of the components to a second minimum supply level.

12. The computer system of claim 11, wherein the second minimum supply voltage level is higher than the first minimum supply voltage level.

13. The computer system of claim 11, wherein the second minimum supply voltage level is lower than the first minimum supply voltage level.

14. The computer system of claim 11, wherein:
the VMS module is further configured to:
recognize that the temperature threshold has been crossed a second time; and
the SVS module is further configured to:
adjust the second minimum voltage supply level back to the first minimum voltage supply level.

15. The computer system of claim 11, wherein at least one of the one or more temperature sensors is a die level temperature sensor.

16. The computer system of claim 15, wherein the die level temperature sensor is associated with a junction.

17. The computer system of claim 11, wherein at least one of the one or more temperature sensors is associated with an outer shell aspect of the PCD.

18. The computer system of claim 11, wherein:
the VMS module is further configured to:
define a second operating temperature threshold in the PCD, wherein the operating temperature threshold represents a temperature below which one or more components in the PCD cannot maintain timing closure at the second minimum supply voltage level; and
receive a signal from one of the one or more temperature sensors, wherein the signal indicates that the second operating temperature threshold has been crossed; and
the SVS module is further configured to:
adjust the second minimum supply voltage level of one or more of the components to a third minimum supply level.

19. The computer system of claim 18, wherein the third minimum supply voltage level is higher than the second minimum supply voltage level.

20. The computer system of claim 18, wherein the third minimum supply voltage level is lower than the second minimum supply voltage level.

21. A computer system for voltage mode selection in a portable computing device, the system comprising:
means for defining a first operating temperature threshold in the PCD, wherein the operating temperature threshold represents a temperature below which one or more components in the PCD cannot maintain timing closure at a first minimum supply voltage level;
means for monitoring one or more temperature sensors in the PCD;
means for receiving a signal from one of the one or more temperature sensors, wherein the signal indicates that the first operating temperature threshold has been achieved; and
means for adjusting the first minimum supply voltage level of one or more of the components to a second minimum supply level in response to the first operating temperature threshold being achieved.

22. The computer system of claim 21, wherein the second minimum supply voltage level is higher than the first minimum supply voltage level.

23. The computer system of claim 21, wherein the second minimum supply voltage level is lower than the first minimum supply voltage level.

24. The computer system of claim 21, further comprising:
means for recognizing that the temperature threshold has been crossed a second time; and
means for adjusting the second minimum voltage supply level back to the first minimum voltage supply level.

25. The computer system of claim 21, wherein at least one of the one or more temperature sensors is a die level temperature sensor.

26. The computer system of claim 25, wherein the die level temperature sensor is associated with a junction.

27. The computer system of claim 21, wherein at least one of the one or more temperature sensors is associated with an outer shell aspect of the PCD.

28. The computer system of claim 21, further comprising:
means for defining a second operating temperature threshold in the PCD, wherein the operating temperature threshold represents a temperature below which one or more components in the PCD cannot maintain timing closure at the second minimum supply voltage level;
means for receiving a signal from one of the one or more temperature sensors, wherein the signal indicates that the second operating temperature threshold has been crossed; and
means for adjusting the second minimum supply voltage level of one or more of the components to a third minimum supply level.

29. The computer system of claim 28, wherein the third minimum supply voltage level is higher than the second minimum supply voltage level.

30. The computer system of claim 28, wherein the third minimum supply voltage level is lower than the second minimum supply voltage level.

31. A computer program product comprising a computer usable medium having a computer readable program code embodied therein, said computer readable program code adapted to be executed to implement a method for voltage mode selection in a portable computing device, said method comprising:
defining a first operating temperature threshold in the PCD, wherein the operating temperature threshold represents a temperature below which one or more components in the PCD cannot maintain timing closure at a first minimum supply voltage level;
monitoring one or more temperature sensors in the PCD;
receiving a signal from one of the one or more temperature sensors, wherein the signal indicates that the first operating temperature threshold has been achieved; and
in response to the first operating temperature threshold being achieved, adjusting the first minimum supply voltage level of one or more of the components to a second minimum supply level.

32. The computer program product of claim 31, wherein the second minimum supply voltage level is higher than the first minimum supply voltage level.

33. The computer program product of claim 31, wherein the second minimum supply voltage level is lower than the first minimum supply voltage level.

34. The computer program product of claim 31, further comprising:
recognizing that the temperature threshold has been crossed a second time; and
adjusting the second minimum voltage supply level back to the first minimum voltage supply level.

35. The computer program product of claim 31, wherein at least one of the one or more temperature sensors is a die level temperature sensor.

36. The computer program product of claim 35, wherein the die level temperature sensor is associated with a junction.

37. The computer program product of claim 31, wherein at least one of the one or more temperature sensors is associated with an outer shell aspect of the PCD.

38. The computer program product of claim 31, further comprising:
defining a second operating temperature threshold in the PCD, wherein the operating temperature threshold represents a temperature below which one or more components in the PCD cannot maintain timing closure at the second minimum supply voltage level;
receiving a signal from one of the one or more temperature sensors, wherein the signal indicates that the second operating temperature threshold has been crossed; and
adjusting the second minimum supply voltage level of one or more of the components to a third minimum supply level.

39. The computer program product of claim 38, wherein the third minimum supply voltage level is higher than the second minimum supply voltage level.

40. The computer program product of claim 38, wherein the third minimum supply voltage level is lower than the second minimum supply voltage level.
